(19) United States
(12) Patent Application Publication
(10) Pub. No.: US 2020/0348153 A1
(43) Pub. Date: Nov. 5, 2020

(54) ENCODER STRIP MOUNTING SYSTEM

(71) Applicant: HEWLETT-PACKARD DEVELOPMENT COMPANY, L.P., Spring, TX (US)

(72) Inventors: Matt G DRIGGERS, Vancouver, WA (US); Drew BERWAGER, Vancouver, WA (US)

(73) Assignee: Hrwlett-Packard Development Company, L.P., Spring, TX (US)

(21) Appl. No.: 16/608,462

(22) PCT Filed: Dec. 5, 2017
(86) PCT No.: PCT/US2017/064656

§ 371 Date: Oct. 25, 2019

(51) Int. Cl. G01D 5/26; G01D 5/347; B41J 29/42; B41J 29/02; B41J 2/045; B29C 64/393; B29C 37/00

(52) U.S. Cl. CPC G01D 5/264; G01D 5/34746; B41J 29/42; B29C 2037/906; B41J 2/04553; B29C 64/393; B29C 37/00; B41J 29/02

(57) ABSTRACT

In one example, an encoder strip mounting system includes an encoder strip having a first end, a second end opposite the first end, and an intermediate part between the first end and the second end, and a retainer to prevent the intermediate part of the encoder strip from shifting lengthwise with respect to an anchor point for the retainer located within a span of the intermediate part of the encoder strip.

### BACKGROUND

A linear encoder is a sensor paired with a scale that encodes position. The sensor reads the scale along an encoder strip to convert the encoded position into an analog or digital signal, which can then be decoded into a position for a motion controller.

### DRAWINGS

FIG. 1 is an elevation view illustrating one example of an encoder strip mounting system.

FIGS. 2-9 are isometric views illustrating another example of an encoder strip mounting system.

FIGS. 10 and 11 are isometric views illustrating a carriage with a reader to read scale markings on a linear encoder strip mounted with the example mounting system shown in FIGS. 2-9.

FIGS. 12-14 illustrate examples of a retainer for an encoder strip mounting system like the system shown in FIGS. 2-9.

FIGS. 15-24 are elevation and plan views illustrating one example of a fusing system for an additive manufacturing machine.

The same part numbers designate the same or similar parts throughout the figures. The figures are not necessarily to scale.

### DESCRIPTION

Linear encoders are used in 2D and 3D printing to help accurately dispense ink and other liquids from dispensers carried back and forth over the work area. The accuracy of a linear encoder may be effected by the expansion and contraction of the encoder strip caused by temperature changes.

A new encoder strip mounting system has been developed to help reduce the effect of temperature changes on the accuracy of the encoder. In one example, the mounting system includes first and second anchors anchoring each end of the encoder strip and a third, intermediate anchor anchoring an intermediate part of the encoder strip between the first and second anchors. A retainer connected between the third anchor and the intermediate part of the encoder strip prevents the intermediate part of the encoder strip from shifting lengthwise with respect to the intermediate anchoring point. This third, intermediate anchor is located within the length of the work area so that the position of the encoder strip remains stationary with respect to a work piece in the work area, even during temperature changes, thus helping the encoder more accurately indicate the position of a carriage along the strip relative to the work piece.

The examples shown and described illustrate but do not limit the scope of the patent, which is defined in the Claims following this Description.

As used in this document, “and/or” means one or more of the connected things.

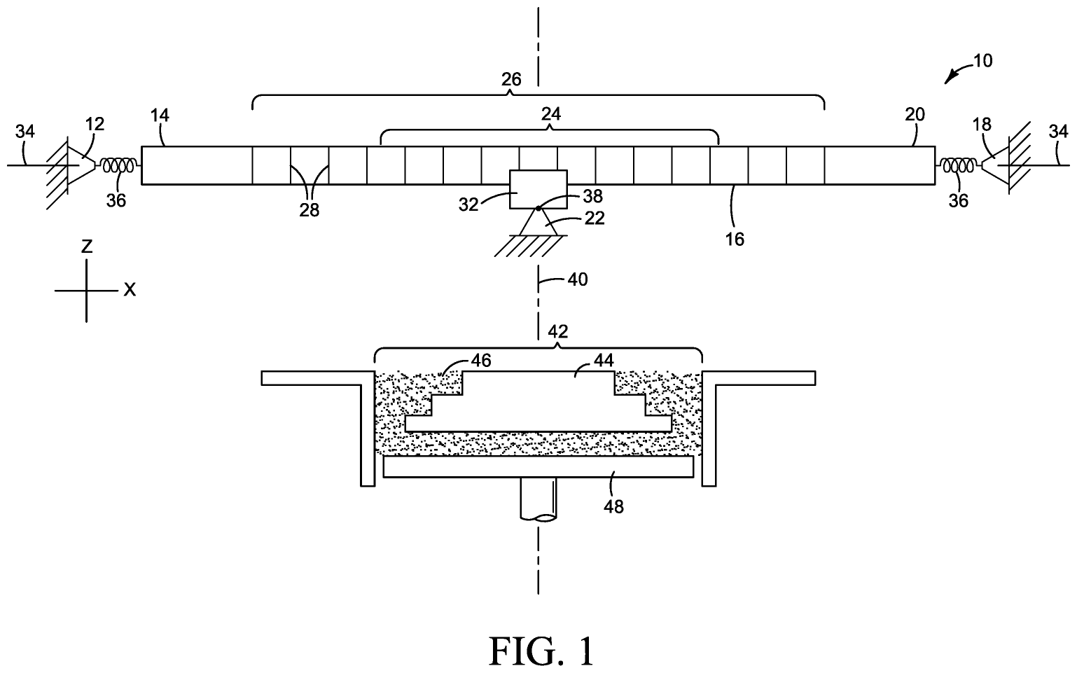

FIG. 1 illustrates one example of an encoder strip mounting system 10. Referring to FIG. 1, mounting system 10 includes a first anchor 12 anchoring one end 14 of a linear encoder strip 16, a second anchor 18 anchoring the other end 20 of encoder strip 16, and a third anchor 22 anchoring an intermediate part 24 of encoder strip 16. A scale 26 with markings 28 is formed along encoder strip 16 and third, intermediate anchor 22 is located within the span of scale 26. Encoder strip 16 is connected to intermediate anchor 22 with a retainer 32. Retainer 32 is rigid in the lengthwise direction, along the long axis 34 of strip 16, to prevent the intermediate part 24 of the encoder strip 16 from shifting lengthwise with respect to anchor 22.

Mounting system 10 provides elasticity along axis 34 to accommodate thermal expansion and contraction, and part tolerances, and thus prevent slack and undue tension in a linear encoder strip 16. Where encoder strip 16 is implemented as an inelastic strip of material, a spring or other suitably elastic member 36 is connected between each end 14, 20 of encoder strip 16 and the corresponding anchor 12, 18, as shown in FIG. 1. In other examples, the desired elasticity may be integrated into the encoder strip itself and/or into each end anchor. Elasticity is introduced into mounting system 10 on both sides of intermediate anchor 22 to prevent slack and undue tension along the full length of encoder strip 16, for example with a spring 36 at each end anchor 12, 18.

Intermediate anchor 22 and retainer 32 prevent the intermediate part 24 of encoder strip 16 from shifting lengthwise with respect to the intermediate anchoring point 38. Anchoring point 38 lies along a transverse, crosswise axis 40 (the Z axis in FIG. 1) within the length of work area 42. When encoder strip 16 expands and contracts, for example due to temperature changes, the ends 14, 20 of strip 16 may shift relative to transverse axis 40, but the intermediate part 24 of strip 16 at anchor 22 remains stationary. When one or both end anchors 12, 18 move, for example as a machine chassis expands and contracts due to temperature changes, the ends 14, 20 of strip 16 may shift along axis 34, but the intermediate part 24 of strip 16 at anchor 22 remains stationary. The effect of temperature changes on strip 16 over work area 42 is localized to intermediate part 24, and thus limited to the expansion and contraction of intermediate part 24 out from and in toward retainer 32.

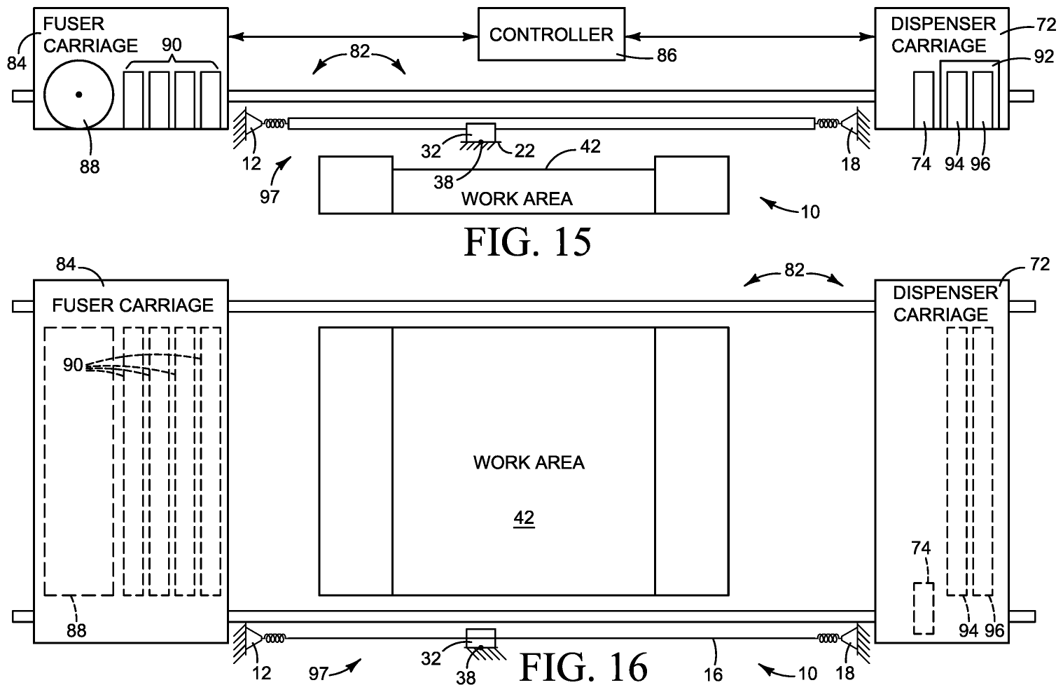

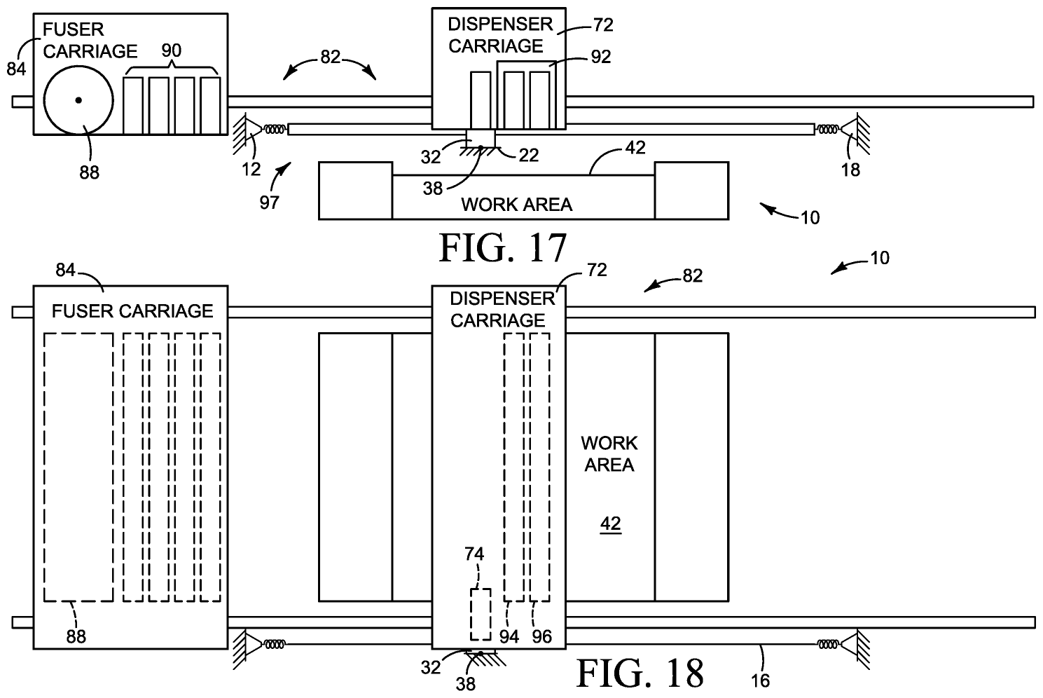

An encoder strip 16 usually will not be positioned within the literal borders of a work area 42, but rather to one side of the work area, for example as shown in FIGS. 15-24. Thus, the “length” of the work area in this context means the length of the work area projected out to the encoder strip 16 intermediate anchoring point 38. Also, as described below with reference to FIGS. 17 and 18, the projected length of the work area may be offset from the actual length of the work area if the strip reader is offset from the center of the functional elements carried along encoder strip 16.

In the example shown in FIG. 1, intermediate anchor point 38 is centered over the work area 42 in an additive manufacturing machine. An object 44 is manufactured by fusing build material powder 46 in a succession of thin layers on a platform 48. As described below with reference to the example shown in FIGS. 15-24, a dispenser (not shown in FIG. 1) is carried back and forth over work area 42 to dispense a liquid fusing agent on to each layer of powder in the desired pattern for object 44, based on reading scale markings 28 along encoder strip 16. A third, intermediate anchor 22 limits the effect of any expansion and/or contraction of strip 16 to intermediate part 24 over work area 42. And, where intermediate anchor point 38 is aligned to the center of work area 42, as shown in FIG. 1, the limited effect of any expansion and/or contraction of intermediate part 24 along strip 16 is distributed equally to each side of the work area.

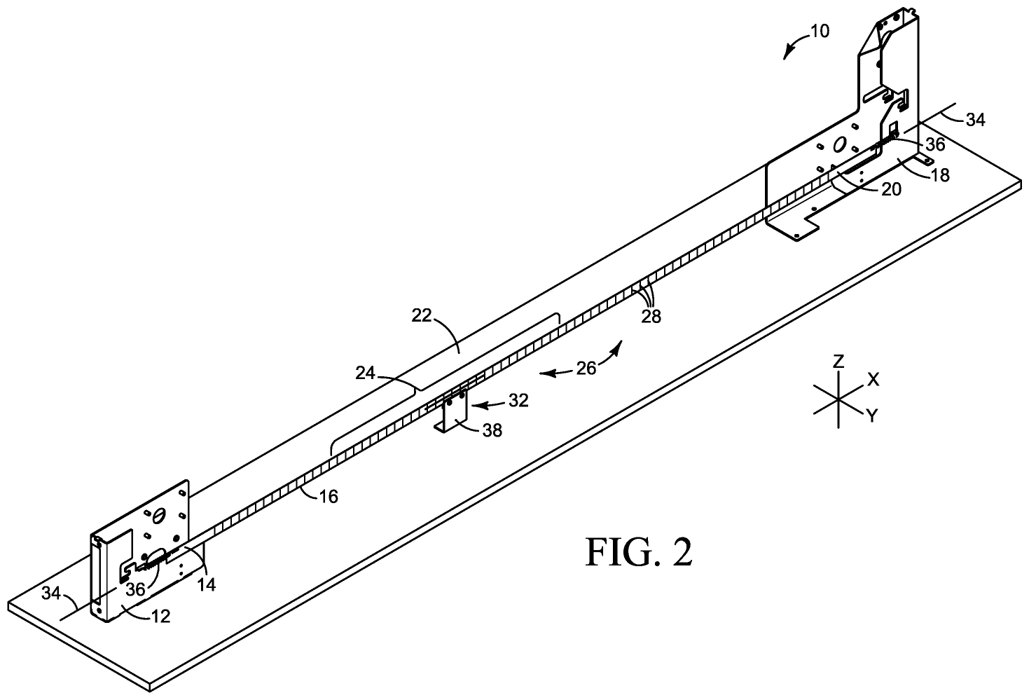

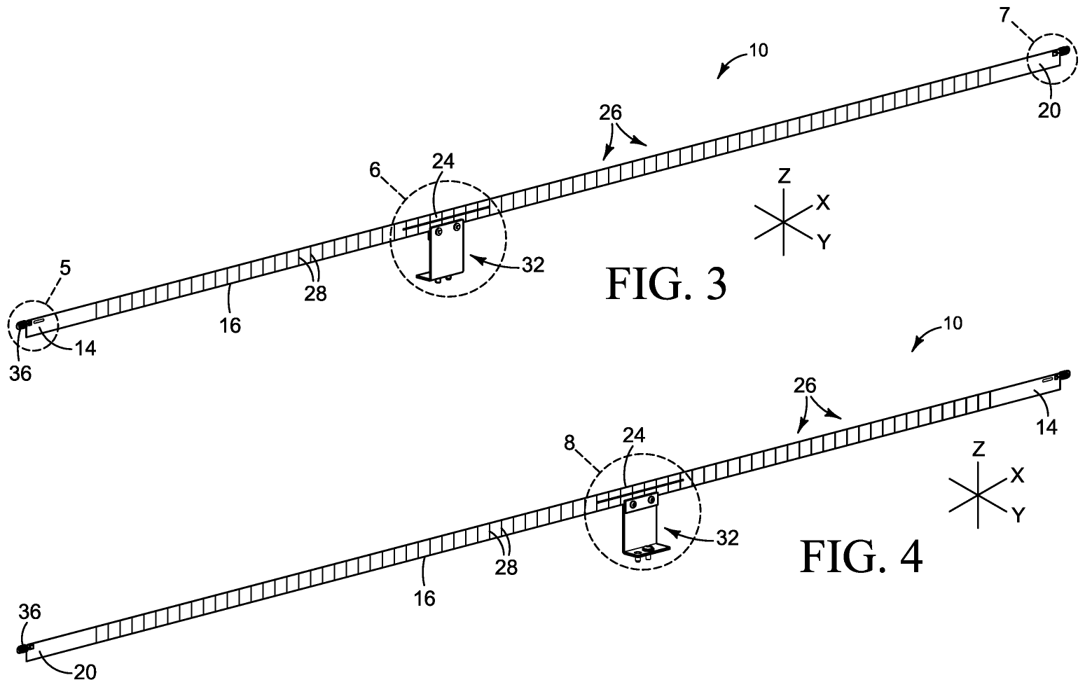

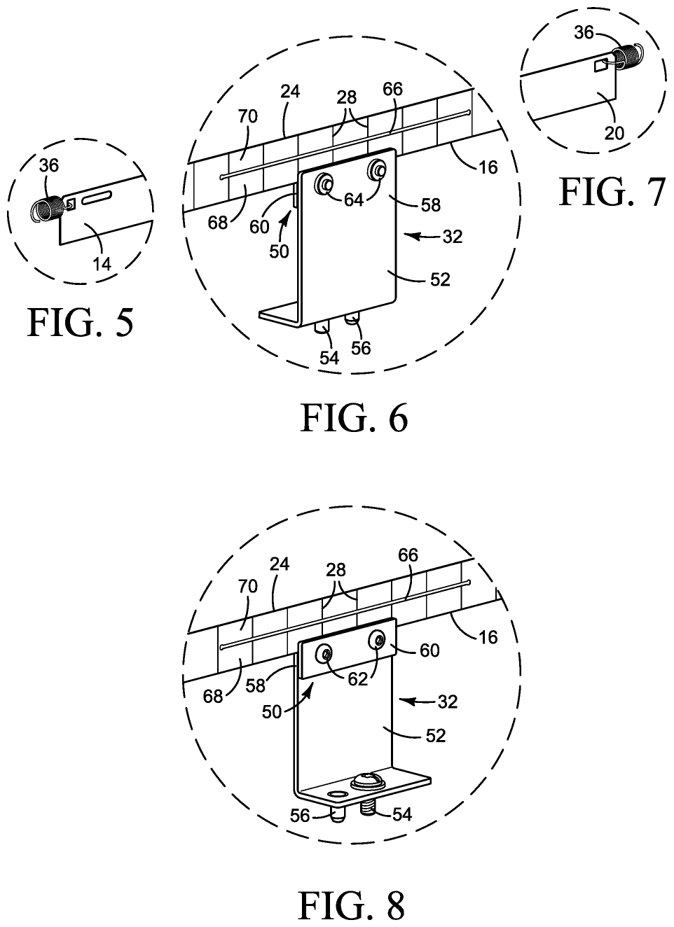

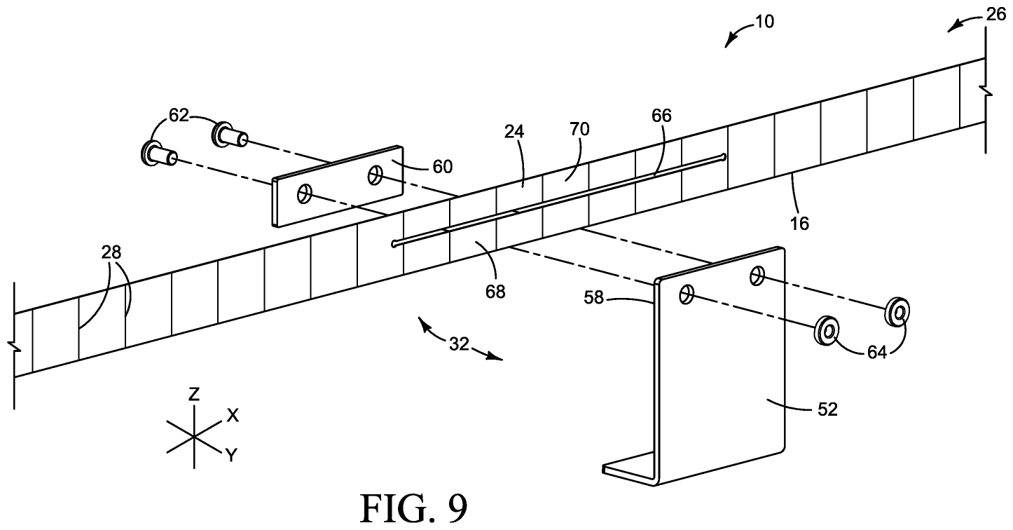

FIGS. 2-9 are isometric views illustrating one example of an encoder strip mounting system 10. Referring first to FIGS. 2-4, mounting system 10 include a first anchor 12 anchoring one end 14 of a linear encoder strip 16, a second anchor 18 anchoring the other end 20 of encoder strip 16, and a third anchor 22 anchoring an intermediate part 24 of encoder strip 16. A scale 26 with markings 28 is formed along encoder strip 16 and third anchor 22 is located within the span of scale 26. Encoder strip 16 is connected to the third, intermediate anchor 22 with a retainer 32. Retainer 32 is rigid in the lengthwise direction, along the long axis 34 of strip 16, to prevent intermediate part 24 from shifting lengthwise with respect to anchor 22. A spring 36 is connected between each end 14, 20 of encoder strip 16 and the corresponding anchor 12, 18.

Referring now also to the detail views of FIGS. 6, 8 and 9, in this example retainer 32 includes a clamp 50 and an L shaped bracket 52 attached to intermediate anchor 22, for example with a screw 54. A pin 56 affixed to bracket 52 may be used to help secure bracket 52 in the desired position against anchor 22. In this example, clamp 50 includes jaws 58, 60 and bolts 62 and nuts 64 to close jaws 58, 60. Encoder strip 16 is clamped to bracket 52 between jaws 58, 60. The clamping force is sufficiently strong and bracket 52 is sufficiently rigid in the lengthwise direction 34 to prevent the intermediate part 24 of encoder strip 16 from shifting lengthwise with respect to anchor point 38. In one example, jaws 58, 60 are closed after the position of strip 16 has been adjusted to the desired location in the crosswise direction (the Z direction in the figures).

In this example, a slot 66 is formed in encoder strip 16 along intermediate part 24. Strip 16 is clamped to bracket 52 along one part 68 of the strip to allow flexibility of the other part 70 of strip 16 near anchor 22.

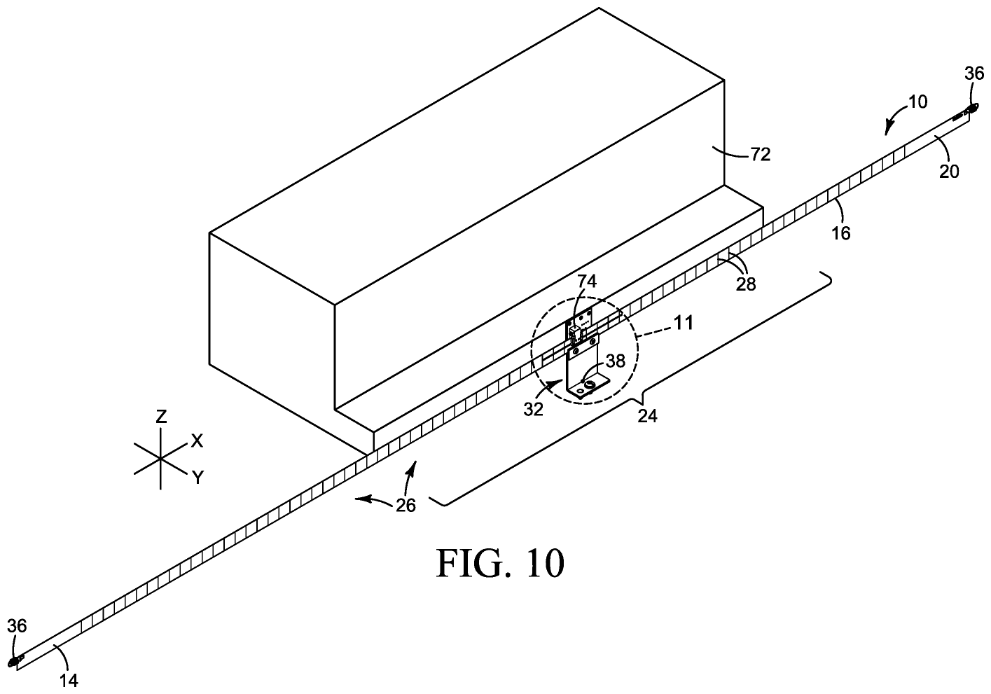

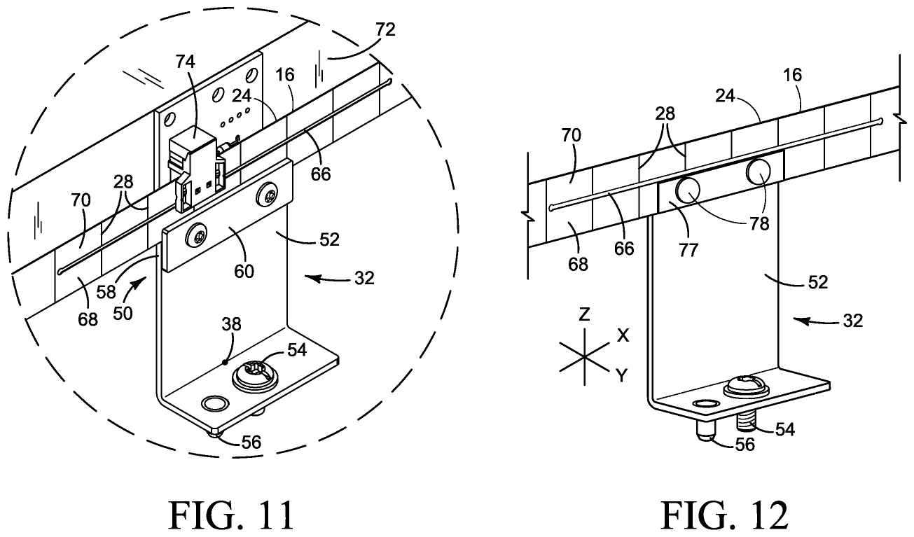

FIGS. 10 and 11 illustrate a carriage 72 with a reader 74 to read scale markings 28 as carriage 72 is moved back and forth along strip 16. As best seen in the detail view of FIG. 11, reader 72 covers strip part 70 along slot 66. The flexibility added to part 70 by slot 66 helps the mounting system accommodate lateral (the Y direction) misalignment between strip 16 and reader 74 by allowing the strip to flex more in the vicinity of anchor 22 compared to an unslotted strip. For example, for a polyester or other such inelastic flexible encoder strip 11 mm across (the Z direction) clamped to a 30mm long (the X direction) bracket 52, testing indicates a slot 1.0mm across and 100mm long will allow sufficient flexibility along strip 16 to limit the risk of introducing reading errors due to any sudden localized bending of strip 16 that may occur as reader 72 passes retainer 32 if the retainer is misaligned to the reader in the Y direction. The length of a slot 66 adds flexibility and the width of the slot 66 helps prevent the edges of the slot from interfering with the added flexibility.

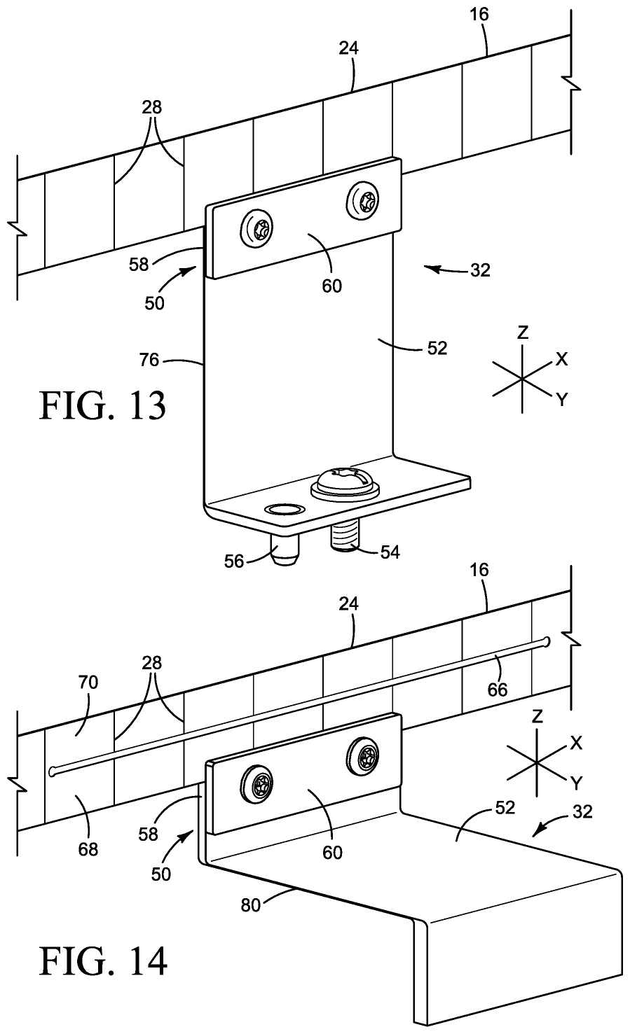

Any suitable retainer 32 may be used. FIGS. 12-14 illustrate other examples of a retainer 32. In the example shown in FIG. 12, bracket 52 is pinned to part 68 of a slotted strip 16, for example with a plate 77 glued or otherwise affixed to strip 16 and bolts or rivets 78. In the example shown in FIG. 13, bracket 52 includes a flexible part 76 that allows clamp 50 and thus an unslotted strip 16 to flex laterally (the Y direction) to help the mounting system accommodate lateral misalignment between strip 16 and reader 74. In the example shown in FIG. 14, a Z shaped bracket 52 includes a flexible part 80 that allows clamp 50 and thus strip 16 to flex crosswise (the Z direction) to help the mounting system accommodate transverse misalignment between strip 16 and reader 74.

Any suitable type of linear encoder may be used with mounting system 10 including, for example, an optical encoder or a magnetic encoder. While a vertically oriented encoder strip 16 is shown in the figures, other suitable orientations for an encoder strip 16 are possible.

FIGS. 15 and 16 are elevation and plan views, respectively, illustrating one example of a fusing system 82 for an additive manufacturing machine. Additive manufacturing machines are commonly referred to as 3D printers. Referring to FIGS. 15 and 16, fusing system 82 includes a first, “fuser” carriage 84 and a second, “dispenser” carriage 72. Carriages 84 and 72 move back and forth over a work area 42 at the direction of a controller 86. Controller 86 represents the processing and memory resources and the instructions, electronic circuitry and components needed to control the operative elements of fusing system 82. In this example, fuser carriage 84 carries a layering device 88 and a group of heating lamps 90. Dispenser carriage 72 carries an inkjet printhead assembly or other suitable liquid dispensing assembly 92 to dispense a liquid fusing agent. In the example shown, dispensing assembly 92 includes a first dispenser 94 to dispense a fusing agent and a second dispenser 96 to dispense a detailing agent.

Fusing system 82 also includes a position sensing subsystem 97 to help control the position of dispenser carriage 72 over work area 42. Position sensing subsystem 97 includes a linear encoder strip 16 and a reader 74 on dispenser carriage 72 to read scale markings (not shown in FIGS. 15 and 16) on encoder strip 16. Encoder strip 16 is mounted in fusing system 82 with a mounting system 10 such as one of the example mounting systems shown in FIGS. 2-14.

FIGS. 17 and 18 show fusing system 82 with agent dispensers 94, 96 centered over work area 42 and reader 74 aligned with intermediate anchoring point 38. The intermediate anchor point 38 is offset from the center of work area 42 the same distance reader 74 is offset from the center of dispensers 94, 96 on carriage 72. Accordingly, the effect of any expansion and/or contraction of intermediate part 24 along strip 16 is distributed equally to each side of work area 42 with respect to the position of dispensers 94, 96 on carriage 74. Equally distributing expansion and contraction to each side of the work area may be desirable in some 3D printing implementations to help maintain symmetry in an object 44 (FIG. 1) as it is manufactured.

Work area 42 in a fusing system 82 represents any suitable structure to support or contain build material for fusing, including underlying layers of build material and in-process slice and other object structures. For a first layer of build material, work area 42 may be formed on the surface of a platform 48 (FIG. 1) that moves up and down to accommodate the layering process. For succeeding layers of build material, work area 42 may be formed on an underlying object structure which may include unfused and fused build material. In FIGS. 15 and 16, fuser carriage 84 and dispenser carriage 72 are parked, awaiting the next build cycle.

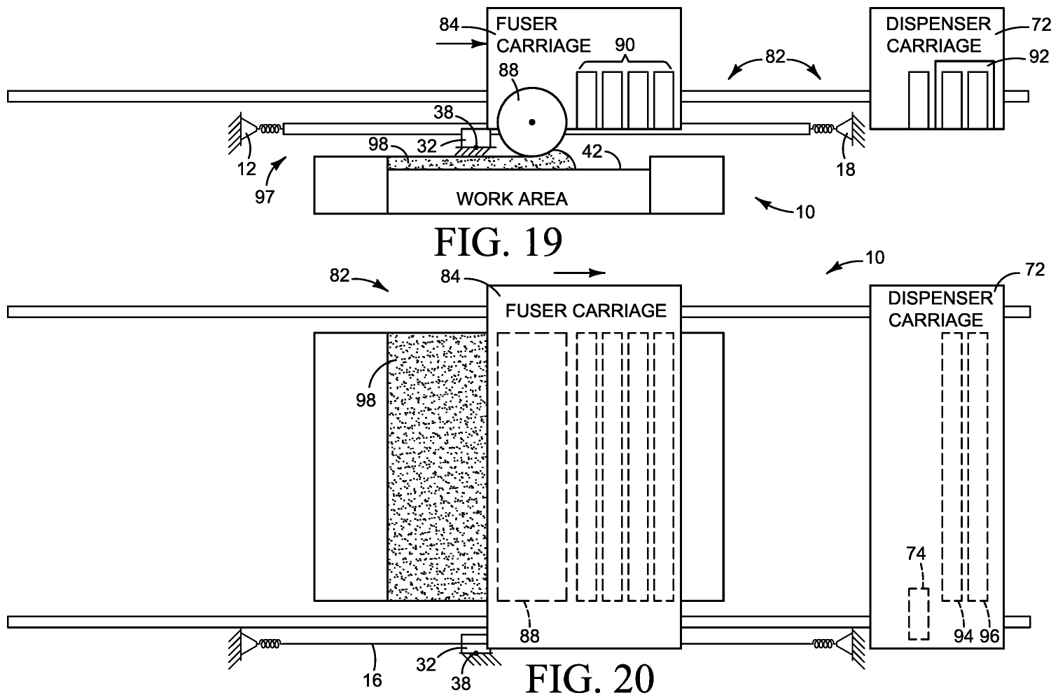

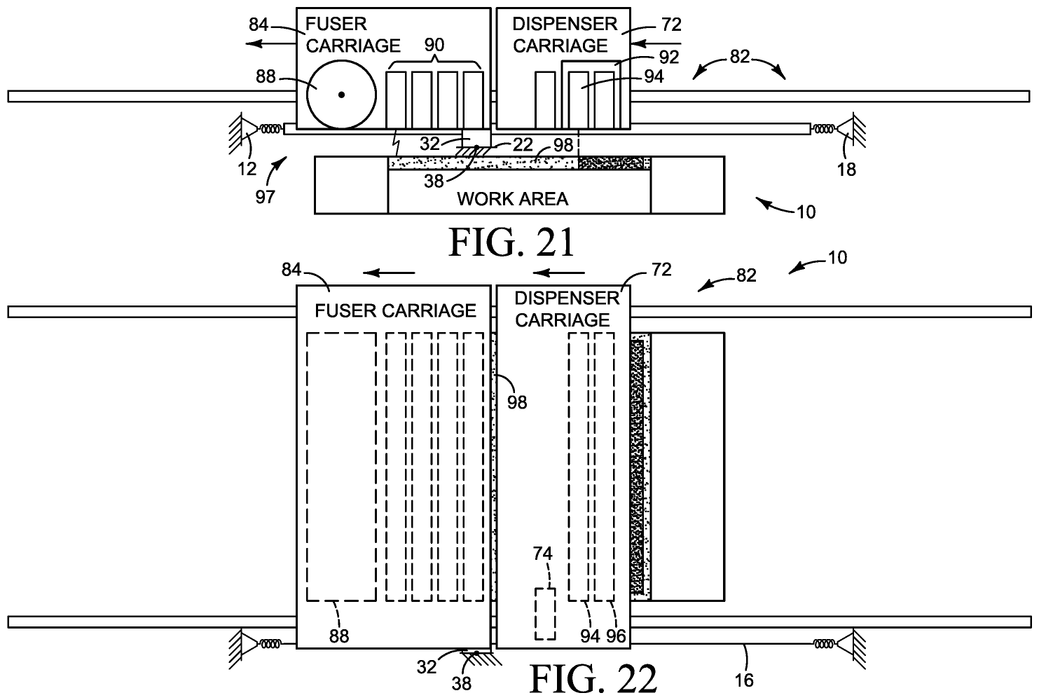

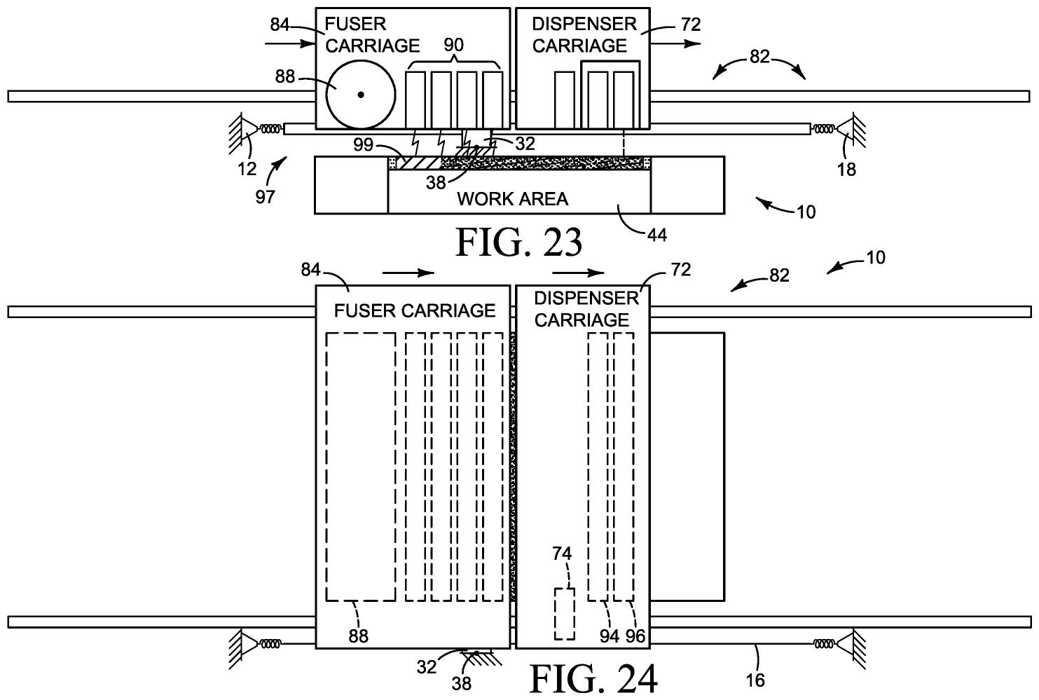

FIGS. 19-24 illustrate one example fusing process for additive manufacturing implemented with fusing system 82. In FIGS. 19 and 20, layering roller 88 is deployed to layer build material 46 over platform 48 as fuser carriage 84 is scanned over work area 42. In FIGS. 21 and 22, fuser carriage 84 is moved to the left with layering roller 88 retracted and a lamp 90 energized to preheat unfused build material in layer 98. As dispenser carriage 74 follows fusing carriage 84 over work area 42, dispenser 94 dispenses fusing agent on to layer 98 in a pattern corresponding to an object slice. In FIGS. 23 and 24, as dispenser carriage 72 is moved back to the right, dispenser 96 dispenses a detailing agent on to layer 98 to further define the object slice. Fusing carriage 84 follows dispenser carriage 72 with lamps 90 energized to fuse patterned build material into an object slice 99. The sequence of operations shown in FIGS. 19-24 is repeated for each successive slice of the object.

The examples shown in the figures and described above illustrate but do not limit the patent, which is defined in the following Claims.

“A”, “an” and “the” used in the claims means one or more.

1. An encoder strip mounting system, comprising:
an encoder strip having a first end, a second end opposite the first end, and an intermediate part between the first end and the second end; and
a retainer to prevent the intermediate part of the encoder strip from shifting lengthwise with respect to an anchor point for the retainer located within a span of the intermediate part of the encoder strip.

2. The system of claim 1, where the retainer is rigid in the lengthwise direction to prevent the intermediate part of the encoder strip from shifting lengthwise when anchored at the anchor point.

3. The system of claim 2, where the retainer includes a clamp to clamp the intermediate part of the encoder strip.

4. The system of claim 2, where the retainer includes a pin to pin the retainer to the intermediate part of the encoder strip.

5. An encoder strip mounting system, comprising:
an encoder strip having a first end, a second end opposite the first end, and an intermediate part between the first end and the second end;
a first anchor anchoring the first end of the encoder strip;
a second anchor anchoring the second end of the encoder strip;
a third anchor anchoring the intermediate part of the encoder strip to an intermediate anchor point; and
a retainer connected between the third anchor and the intermediate part of the encoder strip, the retainer being rigid in a lengthwise direction to prevent the intermediate part of the encoder strip from shifting lengthwise with respect to the intermediate anchor point.

6. The system of claim 5, comprising an elastic member connected between the first anchor and the first end of the encoder strip to pull lengthwise on the first end of the encoder strip and between the second anchor and the second end of the encoder strip to pull lengthwise on the second end of the encoder strip.

7. The system of claim 6, where the elastic member comprises:
a first spring connected between the first anchor and the first end of the encoder strip to pull lengthwise on the first end of the encoder strip; and
a second spring connected between the second anchor and the second end of the encoder strip to pull lengthwise on the second end of the encoder strip.

8. The system of claim 6, where the retainer is flexible in a lateral direction and/or in a crosswise direction.

9. The system of claim 6, where the retainer includes a clamp clamping the intermediate part of the encoder strip to the retainer.

10. The system of claim 6, where the retainer includes a pin pinning the intermediate part of the encoder strip to the retainer.

11. The system of claim 6, where the intermediate part of the encoder strip includes a first lengthwise part with markings, a second lengthwise part, and a slot separating the first part and the second part, the retainer connected to the second part of the encoder strip such that the markings on the first part of the encoder strip are not obstructed by the retainer.

12. A position sensing system for an additive manufacturing machine having a work area within which an object is built and a carriage operatively connected to the encoder strip to carry a manufacturing component back and forth over the work area, the system comprising:
a linear encoder strip having a first end, a second end opposite the first end, an intermediate part between the first end and the second end, and markings on the intermediate part of the encoder strip to indicate position lengthwise within the work area;
a reader on the carriage to read the markings on the intermediate part of the encoder strip;
a first anchor anchoring the first end of the encoder strip;
a second anchor anchoring the second end of the encoder strip;
a third anchor anchoring the intermediate part of the encoder strip lengthwise at an intermediate anchor point within a length of the work area; and
a retainer connected between the third anchor and the intermediate part of the encoder strip to prevent the intermediate part of the encoder strip from shifting lengthwise with respect to the intermediate anchor point.

13. The system of claim 12, where the intermediate anchor point is positioned within the length of the work area such that the manufacturing component carried by the carriage is centered lengthwise over the work area when the reader is aligned with the intermediate anchor point.

14. The system of claim 12, comprising:
a first spring connected between the first anchor and the first end of the encoder strip to pull lengthwise on the first end of the encoder strip; and
a second spring connected between the second anchor and the second end of the encoder strip to pull lengthwise on the second end of the encoder strip.

15. The system of claim 12, where:
the markings include optical markings; and
the reader includes an optical reader.
